(19) United States
(12) Patent Application Publication
(10) Pub. No.: US 2009/0248519 A1
(43) Pub. Date: Oct. 1, 2009

(54) Rewarding internet service, advertisement, and usage method

(76) Inventor: Yoram Mikael Ghassabian, Great Neck, NY (US)

Correspondence Address: Aleksandr Smushkovich, POB 140505, Brooklyn, NY, 11214, US

(21) Appl. No.: 12/382,499

(22) Filed: Mar. 13, 2009

Related U.S. Application Data
(60) Provisional application No. 61/128,418, filed on May 22, 2008.
(60) Provisional application No. 61/070,960, filed on Mar. 27, 2008.

(51) Int. Cl. G06Q 30/00; G06Q 40/00

(52) U.S. Cl. 705/14; 705/26; 705/35; 705/39

(57) ABSTRACT

A rewarding Internet service, advertisement, and usage method is presented, which method in a main preferred embodiment comprises establishing a reward program by an issuer of credit/debit card, providing credit/debit card reward units to a member of the reward program, if the member is a user of at least one Internet service, and takes at least one of the following steps: registering, signing in to the Internet service, using the Internet service, and receiving the reward units onto the member's account. A plurality of embodiments are disclosed specifying a variety of the reward units and Internet service types, member's relations with the issuer and Internet service, combinations thereof, include an entity separate from the issuer and Internet service. Some embodiments include the Internet service represented by a global Internet service website optionally linked with the issuer's website. The method is particularly attractable to Internet advertisers and credit/debit card holders.

### CROSS REFERENCE TO RELATED APPLICATIONS

The present U.S. utility patent application claims the benefit under 35 USC 119 (e) of a U.S. provisional patent application No. 61/128,418 filed on 22 May 2008, and a U.S. provisional patent application No. 61/070,960 filed on 27 Mar. 2008, whose disclosures are hereby incorporated in their entirety by reference. This application disclosure also contains newly disclosed ramifications that do not claim the aforesaid benefit.

### FIELD OF THE INVENTION

The present invention relates to Internet advertising, communications, and usage methods, particularly to methods providing credit/debit card reward units, of the reward program of a credit/debit card issuer, to a member/user that interacts with and/or utilizes various Internet services associated with a publisher and generally linked to a number of advertisers.

### BACKGROUND OF THE INVENTION

There is known an online reward system implemented by Bank of America® (a publisher): https://rewardsshoppingmall.bankofamerica.com/worldpoints/jsp/home.jsp, which provides its users with reward points for each dollar spent for purchasing goods/services from a number of companies (e.g. The Home Depot®, Office Depot®, HP®, etc.) associated with the publisher and placing online ads on its website.

A shortcoming of the mentioned system is that it is oriented mostly to commercial companies, which is why the reward points are issued to the users only if they have actually purchased goods/services from an associated advertiser company. Nevertheless, many advertisers would have benefits by placing their ads through an efficient online system that could attract more visitors to their websites by rewarding said visitors with credit/debit card reward units of their respective credit/debit card issuers and this without the need for said visitors to purchase anything.

There is also known another online rewarding search engine Internet service implemented by www.myguide.com. This search engine Internet service provides its users with reward points for registering, for conducting searches, and for clicking on search result links it publishes.

A major shortcoming of the above mentioned search engine Internet service is that its users have to start collecting, from the beginning, and all over again, reward points issued from this new and independent reward program, and this even if said users are almost certainly already members of already existing and sophisticated reward programs offered by their credit/debit card issuers. Moreover, the necessity for these users to start winning reward points from the beginning and all over again, could lead said users to perform abusive clicks on search result links published by this search engine just for the sake of winning reward points, and this without any good faith interest for the searches themselves. This conduct could hurt financially advertisers advertising with this search engine.

Therefore, the primary aim of the present invention is the provision of an online service and usage method that can attract more visitors to a commercial/non-commercial Internet website of an advertiser published on Internet services such as web browser services, search engine services, email services etc., and, under predetermined conditions, to reward the visitors, which mostly have used the Internet services, or even have logged in the Internet services.

Other aims of the invention might become apparent to one skilled in the art upon learning the present disclosure.

### SUMMARY OF THE INVENTION

The instant disclosure presents a rewarding Internet service, advertisement, and usage method, which method in a main preferred embodiment comprises: establishing a reward program by an issuer of a credit/debit card if it has not been established before, providing credit/debit card reward units to a member of the reward program, substantially if the member is a user of at least one Internet service, and takes at least one of the following steps of: registering; signing in to the Internet service; using the Internet service; and receiving the reward units onto the member's account. A plurality of embodiments are disclosed herein, specifying a variety of the reward units and Internet service types, member's relations with the issuer and Internet service, and combinations thereof. Some embodiments also include an entity separate from the issuer and Internet service. Other embodiments include the Internet service represented by a global Internet service website optionally linked with the issuer's website, and pages of the websites are displayed thereon in various combinations.

### BRIEF DESCRIPTION OF THE DRAWINGS

FIG. 1 schematically illustrates a sample integrated rewarding global Internet service link, and an integrated rewarding search engine bar, on the web page of the reward program of a credit card issuer.

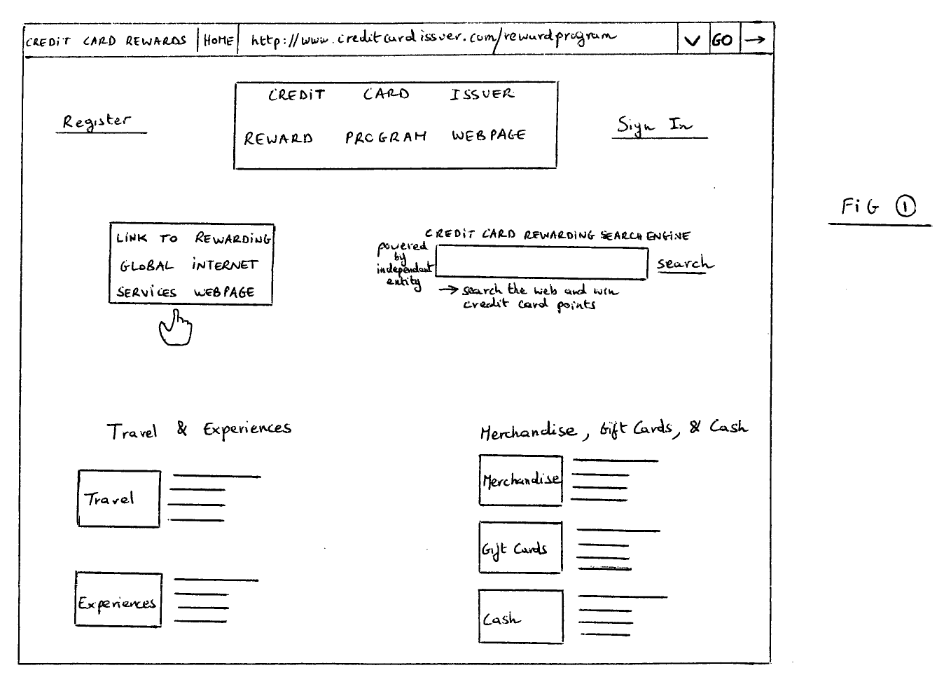

FIG. 2 schematically illustrates a sample advertisement banner on the web page of a rewarding search engine Internet service, with the display, on said web page, of a portion of a web page of an independent Internet search engine service entity.

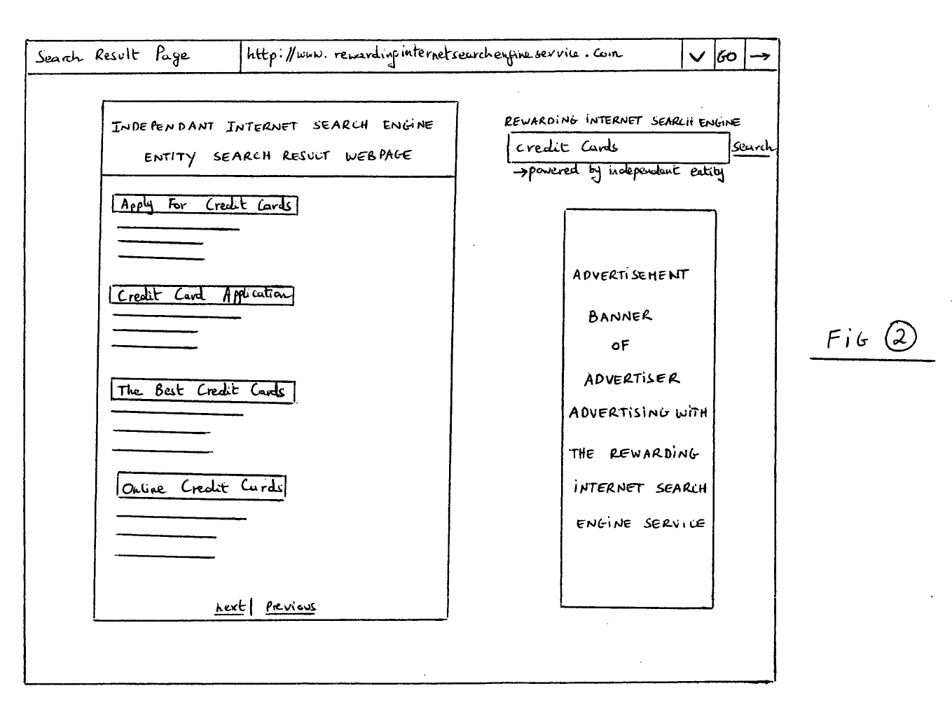

FIG. 3 schematically illustrates a sample login page of a rewarding Internet service integrated on a web page of the reward program of a credit/debit card issuer.

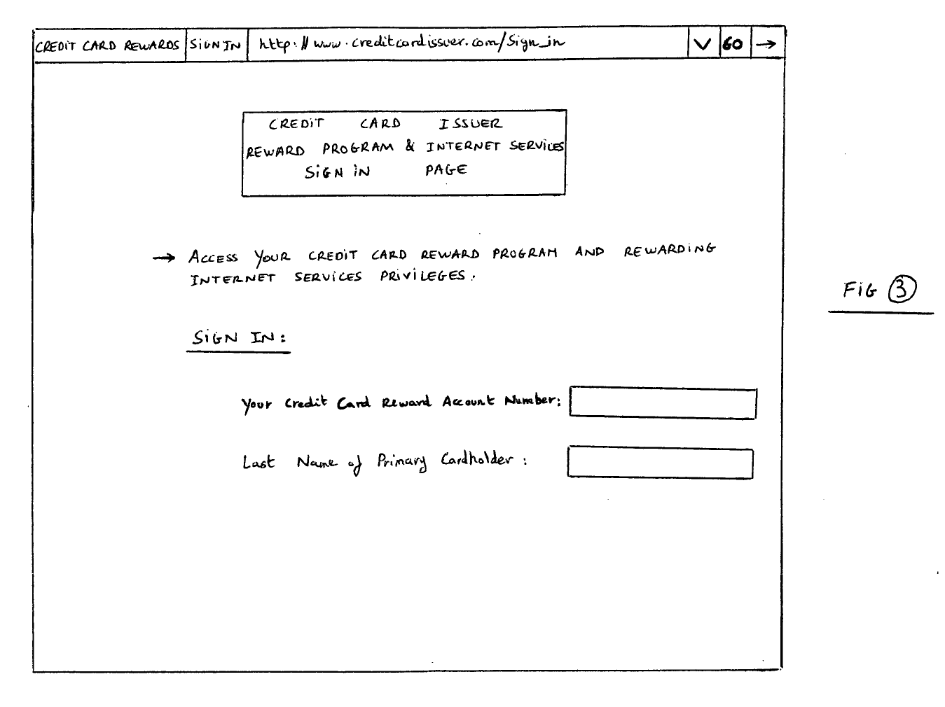

### DESCRIPTION OF PREFERRED EMBODIMENTS OF THE INVENTION

While the invention may be susceptible to embodiment in different forms, there are shown in the drawings, and will be described in detail herein, specific embodiments of the instant invention, with the understanding that the present disclosure is to be considered an exemplification of the principles of the invention, and is not intended to limit the invention to that as illustrated and described herein.

In one preferred embodiment, the inventive Rewarding Internet Service, Advertisement, and Usage Method (RISAUM) generally comprises: establishing a reward program. by an issuer of a credit/debit card; providing credit/debit card reward units to a reward account of a member of a reward program of the issuer of the credit/debit card, if the member is a user of at least one Internet service, and takes the following steps: (a) registering as a registered user of the Internet service, if the member has not been registered before; (b) signing in to said Internet service; and (f) receiving said reward units onto the reward account.

### General Preferred Embodiment

In a general preferred embodiment, the inventive Rewarding Internet Service Advertisement and Usage Method (RISAUM) generally comprises: providing credit/debit card reward units to a user of an Internet service, if the user takes at least one of the following steps of: (a) registering as a registered user of a reward program of the issuer of the credit/debit card, and getting a reward account within the reward program, if the member has not been registered before; (b) registering as a registered user of an Internet service, if the member has not been registered before; (c) signing in to said Internet service; (d) using said Internet service; (f) receiving said reward units onto the reward account.

### Special Case Embodiments of the General Preferred Embodiment

In an embodiment representing a special case of the general preferred embodiment, the RISAUM further comprises an additional step (e) taken by the member after the step (d) and before the step (f). The step (e) consists of the logging out of the Internet service. This means that in such embodiment, the registered user will get some credit/debit card reward units after he/she logs out.

In an embodiment representing a special case of the general preferred embodiment, the RISAUM generally comprises: providing credit/debit card reward units to the registered user anytime said user accesses the Internet service. This feature is useful especially in the case of the user being able to access the Internet service without the need to complete step (c).

In a particular case of the aforesaid embodiment, the member/registered user provides personal information and personal credit/debit card account information when using at least one of the steps of the RISAUM.

In another embodiment representing a special case of the general preferred embodiment of the RISAUM, the Internet service has a website.

In an embodiment representing a special case of the general preferred embodiment of the RISAUM, the Internet service is one of the following: a search engine, a web browser, and an email service.

In an embodiment representing a special case of the general preferred embodiment of the RISAUM, the Internet service is one of the following: a global news service, a sport news service, a financial news service, an entertainment news service, a social space service, an encyclopedia service, a radio player service, a TV player service, a video player service, a music player service, a shopping service, a travel related service, a dating service, a job search service, an auction service, a weather service, an instant message service, a health information service, a yellow pages service, a video game service, a game service, a non-profit donation service, an educational service, a civil service, a legal service, a government-related service, a dictionary service, and a map service.

In a particular case of the aforesaid embodiment, the use of at least one of said Internet services comprises at least one action resulting in the opening of a new web page in the Internet service.

In an embodiment representing a special case of the general preferred embodiment of the RISAUM, the registered user performs the step (d) by doing any type of action related to the use of the Internet service. This embodiment is basically directed to such actions as: opening a new web page on the Internet service; clicking on an advertisement link published on a web page of the Internet service;, entering search keywords; entering web addresses; opening, writing and sending an email; etc.

In an embodiment representing a special case of the general preferred embodiment of the RISAUM, the Internet service has a webpage with an advertisement published thereon, and the use of the Internet service comprises at least an action of selecting said advertisement.

In an embodiment representing a special case of the general preferred embodiment of the RISAUM, the Internet service is a search engine service, and the use of the search engine service comprises at least one of the following actions: (A) entering search keywords, and (B) selecting an advertisement link on a search result page.

In an embodiment representing a special case of the general preferred embodiment of the RISAUM, the Internet service is a web browser service, and the use of the web browser service comprises at least the action of entering a web address.

In an embodiment representing a special case of the general preferred embodiment of the RISAUM, the Internet service is an email service, and the use of the email service comprises at least one of the following actions: (A) opening an email, (B) writing an email, and (C) sending an email.

In an embodiment representing a special case of the general preferred embodiment of the RISAUM, the member/registered user provides personal information and personal credit/debit card account information when using at least one of the steps of the RISAUM.

In a particular case of the aforesaid embodiment, the personal information and personal credit/debit card account information comprise at least one of the following data: (A) credit/debit card reward program account number; (B) name of credit/debit card issuer; (C) name of credit/debit card product; (D) address; (E) phone number; (F) email address; (G) name; (H) first name.

In an embodiment representing a special case of the general preferred embodiment of the RISAUM, the credit/debit card issuer is one of the following: a financial institution, a bank, and a financial network.

In an embodiment representing a special case of the general preferred embodiment of the RISAUM, the credit/debit card reward units are provided in one of the following forms: point rewards, travel miles rewards, cash rewards.

In an embodiment representing a special case of the general preferred embodiment of the RISAUM, the credit/debit card reward units are provided by one of the following: the credit/debit card issuer, and the Internet service.

In an embodiment representing a special case of the general preferred embodiment of the RISAUM, the credit/debit card reward units are provided directly into the reward account of the registered user with the credit/debit card issuer.

In an embodiment representing a special case of the general preferred embodiment of the RISAUM, said Internet service establishes its own reward program, wherein the registered users are provided with corresponding reward accounts, said credit/debit card reward units are transferred directly into the reward account of the registered user with the Internet service, and then transferred into the reward account of the member/registered user with the credit/debit card issuer.

In a particular case of the aforesaid embodiment, the credit/debit card issuer implements a software communication system, the Internet service implements another software communication system, and the credit/debit card reward units are transferred between the credit/debit card issuer and the Internet service using these software communication systems.

In an embodiment representing a special case of the general preferred embodiment of the RISAUM, the credit/debit card issuer implements a software communication system, the Internet service implements another software communication system, each of the software communication systems comprises a database and data processor respectively for storing and processing data related at least to the personal reward account of the member/registered user and the credit/debit card reward units won by the member/registered user while using the Internet service.

In an embodiment representing a special case of the general preferred embodiment of the RISAUM, the Internet service includes a number of web pages incorporating advertisements of advertisers, and the issuance of the credit/debit card reward units is financed at least in part by the advertisers.

In a particular case of the aforesaid embodiment, the advertisers are charged through at least one type of conventional Internet advertising models, such as: Pay Per Click, Cost Per Thousand, Cost Per Impression, etc., advertising models.

In an embodiment representing a special case of the general preferred embodiment of the RISAUM, the reward units provided to the registered user have the same monetary value as the reward units provided to the registered user when he/she uses his/her credit card for common payment purposes.

In an embodiment representing a special case of the general preferred embodiment of the RISAUM, the reward units are ultimately credited into the credit/debit card reward account of the registered user with the credit/debit card issuer and have ultimately the same monetary value and/or same form as the reward units provided to the registered user when he/she uses his/her credit card for common payment purposes. One example of such situation is the instance where the reward units provided by the Internet service do not have, during a first step, the same monetary value and/or the same form than the ones issued by the credit/debit card issuer. But the RISAUM includes any instance where said reward units are ultimately converted, during a second and/or any other further step, into credit/debit card reward units having the same form and/or monetary value than the ones issued by the credit/debit card issuer.

In an embodiment representing a special case of the general preferred embodiment of the RISAUM, the credit/debit card issuer provides a number of web pages, and at least one Internet service is integrated into at least one of the web pages.

In a particular case of the aforesaid embodiment, said at least one integrated Internet service and the credit/debit card issuer implement a software system, which software system manages said number of web pages and said integrated Internet service.

In a particular case of the previous special case embodiment, the member performs the step (b) by registering with the credit/debit card issuer's website, and/or performs the step (c) by signing in to the credit/debit card issuer's website.

In a particular case of the previous special case embodiment, the reward units are provided to the reward account if the member registers with the credit/debit card issuer's website, and starts performing at least one action on the integrated Internet service.

In a particular case of the previous special case embodiment, the reward units are provided to the reward account if the member/registered user signs in to the credit/debit card issuer's website, and starts performing at least one action on the integrated Internet service.

In a particular case of the previous special case embodiment, the name of the integrated Internet service includes references to the name of the credit/debit card issuer's website. For example, if an Internet search engine service is integrated into a web page of a major bank website, said integrated search engine service could be named “A Major Bank Worldpoints Search Engine”.

In an embodiment representing a special case of the general preferred embodiment of the RISAUM, the member/registered user performs any of the steps (b) and (c) either (A) with the credit/debit card issuer's website or (B) with the Internet service.

In an embodiment representing a special case of the general preferred embodiment of the RISAUM, an entity, separate from the Internet service and from the credit/debit card issuer, publishes at least one web page, the Internet service implements a number of web pages, and at least one of the Internet service web pages displays at least a portion of said at least one web page published by the separate entity. For example, a major Internet search engine service is a separate entity from the credit/debit card issuer and the rewarding Internet search engine service. In order to make its search results more accurate, the rewarding Internet search engine service could use the services of the major engine and could display, on at least a portion of at least one of its web pages, at least part of the search engine results of the major engine for any keyword entered by its member/registered user.

In a particular case of the previous special case embodiment, the displayed portion of said at least one web page of said separate entity provides at least a part of services offered by the Internet service.

In a particular case of the previous special case embodiment, at least part of a web page of the Internet service displays advertisements of advertisers advertising with the Internet service next to the displayed portion of said at least one web page published by the separate entity.

In an embodiment representing a special case of the general preferred embodiment of the RISAUM, said Internet service implements a website, and said rewarding method is offered as an option on said website of the Internet service. For example, a conventional search engine website offers on its homepage several options like the ones named “Images”, “Maps”, “News”, “Mail”, and other numerous applications. The user could find and select within these options the RISAUM option and could, if he follows the required steps of this method, be rewarded with credit/debit card reward units.

In an embodiment representing a special case of the general preferred embodiment of the RISAUM, the Internet service has an open access for any user not registered with said Internet service. The Internet service can preferably be used by any user even if he is not registered with it. But the RISAUM and its advantages will preferably be available mostly to registered users.

In an embodiment representing a special case of the general preferred embodiment of the RISAUM, said member being a member of the reward program of the credit/debit card issuer before the step (b).

In an embodiment representing a special case of the general preferred embodiment of the RISAUM, said member becomes a member of the reward program of the credit/debit card issuer during the step (b).

In an embodiment representing a special case of the general preferred embodiment of the RISAUM, said member becomes a member of the reward program of the credit/debit card issuer at any time after the step (b).

In an embodiment representing a special case of the general preferred embodiment of the RISAUM, the registered user receives credit/debit card reward units for remaining a registered user of the Internet service.

In an embodiment representing a special case of the general preferred embodiment of the RISAUM, said Internet service is represented by a global Internet service website offering at least one type of Internet services. An example of a global Internet service website is www.aol.com. This website offers various Internet services like the ones described previously, such as: a web browser service, a search engine service, an email service, a global news service, etc.

In a particular case of the previous special case embodiment, the member/registered user performs any steps of (b) and (c) with any of the Internet services offered by the global Internet service website. The global Internet service website will preferably give the option to the member/registered user to register and/or sign in with any of its Internet services. But it should be understood that the member/registered user can also perform any of steps (b) and (c) only once with the global Internet service website in order to access and/or use any of the rewarding Internet services of said website.

In an embodiment representing a special case of the general preferred embodiment of the RISAUM, said debit/credit card issuer and said Internet service having websites, and the website of said debit/credit card issuer has a link to the website of said Internet service.

In a particular case of the previous special case embodiment, said Internet service website offers several types of Internet services. The link on the website of the credit/debit card issuer could be a link to a global Internet service website.

In a particular case of the previous special case embodiment, said member registers with the Internet service on the website of said debit/credit card issuer.

In a particular case of the previous special case embodiment, said registered user signs in to the Internet service on the website of said debit/credit card issuer.

In a particular case of the previous special case embodiment, said registered user is provided with credit/debit card reward units at least for selecting the link.

In a particular case of the previous special embodiment, the credit/debit card issuer issues a credit/debit card product which provide credit/debit card reward units to be credited in the reward account of the members of the reward program of an affiliate partner of said credit/debit card issuer with said credit/debit card product when said members use said credit/debit card product mostly for payment purposes, and wherein the reward program of said affiliate partner will provide reward units having the same form and/or same monetary value than the ones of the reward program of said credit/debit card issuer if said members are users of at least one Internet service and take any of the steps (b), (c), (d), (e), and/or access said Internet service. One example of such situation is the instance where a credit card issuer like Major Group Bank issues a credit card product which provide credit card reward units to be credited in the reward account of members of the AAdvantage reward program of Major Airlines when said members use the credit card product mostly for payment purposes. Major Airlines is the affiliate partner of Major Group Bank with said AAdvantage credit card. The AAdvantage reward program will provide reward units having the same form and/or same monetary value than the ones issued by the Major Group Bank if the members of the AAdvantage reward program are users of at least one rewarding Internet service and take any of the steps (b), (c), (d), (e), and/or access said Internet service.

In a particular case of the previous special embodiment, the Internet service implements a website and a software program, and offers an option to its registered user to make the website as the default website of said registered user on his/her desktop.

In a particular case of the previous special embodiment, the Internet service website offers cookies software programs to its registered user, in order for said registered user to directly access any web page of said Internet service website at a later stage, and this without the need for said registered user to sign in before in order to benefit from the credit/debit card reward program of said Internet service.

In a particular case of the previous special embodiment, the Internet service implements a software application that can be downloaded on the desktop of the user in any possible form, such as an icon and/or a tool bar.

In a particular case of the previous special embodiment, the Internet service offers to the registered user an option to download a software program on his computer that will record his actions when he is using the Internet, and that will automatically provide his reward account with credit/debit card reward units, when said registered users performs any predetermined rewarding action, and this without the prerequisite requirement to sign in each time to the Internet service before using it.

I claim:

1. A rewarding Internet service, advertisement, and usage method comprising:
establishing a reward program by an issuer of a credit/debit card;
providing credit/debit card reward units to a reward account of a member of said reward program, if the member is a user of at least one Internet service, and takes the following steps:
a) registering as a registered user of a reward program of the issuer of the credit/debit card, and getting a reward account within the reward program, if the member has not been registered before, else going to step (b);
b) registering as a registered user of the Internet service, if the member has not been registered before, else go to step (c);
c) signing in to said Internet service;
d) using said Internet service; and
f) receiving said reward units onto the reward account.

2. The method according to claim 1, further comprising an additional step
e) logging out of said Internet service, taken by said member after the step (d) and before the step (f).

3. The method according to claim 1, wherein the registered user is being provided with credit/debit card units anytime he/she accesses the Internet service.

4. The method according to claim 1, wherein said Internet service implements a website.

5. The method according to claim 1, wherein said Internet service is one of the following: a search engine, a web browser, and an email service.

6. The method according to claim 1, wherein said Internet service is one of the following: a global news service, a sport news service, a financial news service, an entertainment news service, a social space service, an encyclopedia service, a radio player service, a TV player service, a video player service, a music player service, a shopping service, a travel related service, a dating service, a job search service, an auction service, a weather service, an instant message service, a health information service, a yellow pages service, a video game service, a game service, a non-profit donation service, an educational service, a civil service, a legal service, a government-related service, a dictionary service, and a map service.

7. The method according to claim 1, wherein said registered user performs the step (d) by doing any type of action related to the use of the Internet service.

8. The method according to claim 1, wherein said Internet service has a webpage with an advertisement published thereon, and the use of the Internet service comprises at least an action of selecting said advertisement.

9. The method according to claim 1, wherein said Internet service is a search engine service, and the use of the search engine service comprises at least one of the following actions: (A) entering search keywords, and (B) selecting an advertisement link on a search result page.

10. The method according to claim 1, wherein said Internet service is a web browser service, and the use of the web browser service comprises at least the action of entering a web address.

11. The method according to claim 1, wherein said Internet service is an email service, and the use of the email service comprises at least one of the following actions: (A) opening an email, (B) writing an email, and (C) sending an email.

12. The method according to claim 6, wherein the use of at least one of said Internet services comprises at least one action resulting in the opening of a new web page in the Internet service.

13. The method according to claim 1, wherein said member/registered user provides personal information and personal credit/debit card account information when taking at least one of the steps of said method.

14. The method according to claim 2, wherein said member/registered user provides personal information and personal credit/debit card account information when using at least one of the steps of said method.

15. The method according to claim 13, wherein said personal information and personal credit/debit card account information comprise at least one of the following data: (A) credit/debit card reward program account number; (B) name of credit/debit card issuer; (C) name of credit/debit card product; (D) address; (E) phone number; (F) email address; (G) last name; and (H) first name.

16. The method according to claim 1, wherein said credit/debit card issuer is one of the following: a financial institution, a bank, and a financial network.

17. The method according to claim 1, wherein said credit/debit card reward units are provided in one of the following forms: point rewards, travel miles rewards, and cash rewards.

18. The method according to claim 1, wherein said credit/debit card reward units are provided by one of the following: the credit/debit card issuer, and the Internet service.

19. The method according to claim 1, wherein said credit/debit card reward units are provided directly into said reward account of the registered user with the credit/debit card issuer.

20. The method according to claim 1, wherein said Internet service establishes its own reward program wherein the registered users are provided with corresponding reward accounts, said credit/debit card reward units are transferred directly into the reward account of the registered user with said Internet service, and then transferred into the reward account of the registered user with said credit/debit card issuer.

21. The method according to claim 20, wherein said credit/debit card issuer implements a software communication system, the Internet service implements another software communication system, and the credit/debit card reward units are transferred between the credit/debit card issuer and the Internet service using these software communication systems.

22. The method according to claim 1, wherein said credit/debit card issuer implements a software communication system, said Internet service implements another software communication system, each of the software communication systems comprises a database and data processor respectively for storing and processing data related at least to the personal reward account of the member/registered user and the credit/debit card reward units won by said member/registered user while using said Internet service.

23. The method according to claim 1, wherein said Internet service includes a number of web pages incorporating advertisements of advertisers, and the issuance of said credit/debit card reward units is financed at least in part by the advertisers.

24. The method according to claim 23, wherein said advertisers are charged through at least one type of conventional Internet advertising models.

25. The method according to claim 1, wherein said reward units provided to the registered user have the same monetary value as the reward units provided to the registered user when he/she uses his/her credit card for common payment purposes.

26. The method according to claim 1, wherein said reward units are ultimately credited into said credit/debit card reward account of the registered user and have ultimately the same monetary value and/or same form as the reward units provided to the registered user when he/she uses his/her credit card for common payment purposes.

27. The method according to claim 1, wherein said credit/debit card issuer provides a website with a number of web pages, and at least one Internet service is integrated into at least one of said web pages.

28. The method according to claim 27, wherein said at least one integrated Internet service and the credit/debit card issuer implement a software system, said software system manages said website and said at least one integrated Internet service.

29. The method according to claim 27, wherein said member/registered user performs the step (b) by registering with said website of the credit/debit card issuer, and/or performs the step (c) by signing in to said website of the credit/debit card issuer.

30. The method according to claim 27, wherein said reward units are provided to the reward account if said member/registered user registers with said website of the credit/debit card issuer, and starts performing at least one action on the integrated Internet service.

31. The method according to claim 27, wherein said reward units are provided to the reward account if said member/registered user signs in to said website of the credit/debit card issuer, and starts performing at least one action on the integrated Internet service.

32. The method according to claim 27, wherein the name of said integrated Internet service includes references to the name of said website of the credit/debit card issuer.

33. The method according to claim 1, wherein said member/registered user performs any of the steps (b) and (c) with either (A) said website of the credit/debit card issuer, or (B) with the Internet service.

34. The method according to claim 1, further including:
publishing at least one web page by an entity, separate from the Internet service and from the credit/debit card issuer;
implementing a number of web pages by said Internet service; and
displaying at least a portion of said at least one web page published by the separate entity on at least one of said Internet service web pages.

35. The method according to claim 34, wherein said displayed portion of said at least one web page of said separate entity provides at least a part of services offered by the Internet service.

36. The method according to claim 34, wherein at least part of a web page of the Internet service displays advertisements of advertisers advertising with the Internet service next to the displayed portion of said at least one web page published by the separate entity.

37. The method according to claim 1, wherein said Internet service implements a website, and said rewarding method is offered as an option on said website of the Internet service.

38. The method according to claim 1, wherein said Internet service has an open access for any user not registered with said Internet service.

39. The method according to claim 1, wherein said member/registered user being a member of the reward program of the credit/debit card issuer before the step (b).

40. The method according to claim 1, wherein said member/registered user becomes a member of the reward program of the credit/debit card issuer during the step (b).

41. The method according to claim 1, wherein said member/registered user becomes a member of the reward program of the credit/debit card issuer at any time after the step (b).

42. The method according to claim 1, wherein said registered user receives credit/debit card reward units for remaining to be a registered user of the Internet service.

43. The method according to claim 1, wherein said Internet service is represented by a global Internet service website offering at least one type of Internet services.

44. The method according to claim 43, wherein said member/registered user performs any steps of (b) and (c) with any of the Internet services offered by the global Internet service website.

45. The method according to claim 1, wherein said debit/credit card issuer and said Internet service establish websites, and the website of said debit/credit card issuer has a link to the website of said Internet service.

46. The method according to claim 45, wherein said Internet service website offers several types of Internet services.

47. The method according to claim 45, wherein said member registers with the Internet service on the website of said debit/credit card issuer.

48. The method according to claim 45, wherein said registered user signs in to the Internet service on the website of said debit/credit card issuer.

49. The method according to claim 45, wherein said registered user is provided with credit/debit card reward points at least for selecting the link.

50. The method according to claim 1, wherein
said credit/debit card issuer has an affiliate partner having established its own reward program with reward accounts for its members; and
the credit/debit card issuer issues a credit/debit card product, which provide credit/debit card reward units to be credited in the reward account of the members of the reward program of said affiliate partner with said credit/debit card product, when said members use said credit/debit card product for payment purposes, and wherein the reward program of said affiliate partner provides reward units having the same form and/or same monetary value as the ones of the reward program of said credit/debit card issuer, if said members are users of at least one Internet service and take any of the steps (b), (c), (d), (e), and/or access said Internet service.

51. The method according to claim 1, wherein said Internet service implements a website and a software offering an option to said registered user to make said website the default website of said registered user on his/her desktop.

52. The method according to claim 1, wherein said Internet service implements a website offering a cookies software program to said registered user, to provide him/her with direct access to any web page of said website at a later stage, without the need for said registered user to sign in before, in order to benefit from the credit/debit card reward program of said Internet service.

53. The method according to claim 1, wherein said Internet service implements a software program capable to be downloaded on the desktop of the user.

54. The method according to claim 53, wherein said software program is capable to be downloaded on the desktop of the user in the form an icon and/or a tool bar.

55. The method according to claim 1, wherein said Internet service implements a software program that offers to the registered user an option to download it on his/her computer, said program is capable to record his/her actions when he/she uses the Internet, and to automatically provide his/her reward account with credit/debit card reward units, when said registered user performs any predetermined rewarding action, with no prerequisite requirement to sign in each time to the Internet service before using it.

56. A rewarding Internet service, advertisement, and usage method comprising:
establishing a reward program by an issuer of a credit/debit card;
providing credit/debit card reward units to a reward account of a member of said reward program, if the member is a user of at least one Internet service, and takes the following steps:
a) registering as a registered user of the Internet service, if the member has not been registered before, else going to step (b);
b) signing in to said Internet service; and
f) receiving said reward units onto the reward account.
